(19) United States
(12) Patent Application Publication
(10) Pub. No.: US 2026/0129639 A1
(43) Pub. Date: May 7, 2026

(54) SYSTEMS AND METHODS OF SCHEDULING REQUEST ADJUSTMENT

(71) Applicant: Meta Platforms Technologies, LLC, Menlo Park, CA (US)

(72) Inventors: Manjinder Sandhu, San Diego, CA (US); Madhusudan Kinthada Venkata, South San Diego, CA (US)

(21) Appl. No.: 18/077,722

(22) Filed: Dec. 8, 2022

(51) Int. Cl. H04W 72/1268; H04W 52/02; H04W 72/21; H04W 72/566

(52) U.S. Cl. CPC H04W 72/1268; H04W 52/0261; H04W 72/21; H04W 72/566

(57) ABSTRACT

Disclosed herein are devices and methods for adjusting a transmission schedule of scheduling requests (SRs). In one aspect, a wireless communication device receives a configuration to transmit a plurality of SRs for uplink wireless communication in accordance with a periodicity. The periodicity can be defined by a plurality of time intervals. The wireless communication device can determine a state indicative of at least one of a thermal or a battery condition of the wireless communication device. The wireless communication device can determine, in response to the identified state, to delay transmission of a first SR of the plurality of SRs for at least a first time interval of the plurality of time intervals. The wireless communication device can transmit the first SR at a second time interval of the plurality of time intervals in accordance with the determining.

### FIELD OF DISCLOSURE

The present disclosure is generally related to wireless communication, including but not limited to managing scheduling requests in wireless communications.

### BACKGROUND

Cellular communication technology (e.g., 3G, 4G, 5G) allows high data rate communication. In such an environment, a user equipment (UE) can generate and transmit data to a base station. A base station may provide or forward data from the UE onward to the destination. A base station can provide or forward data from another base station to another UE. A network between one or more UEs and a base station may be referred to as a radio access network (RAN).

### SUMMARY

In UEs, such as wearable or mobile devices, heat buildup can lead to deterioration or increased energy consumption of the device if the heat is not properly managed. The same UE devices (sometimes referred to as UE) can have their battery charge running low while the user continues to rely on the UE to remain powered up. The present disclosure provides a solution in which a UE can reconfigure the effective rate of its uplink scheduling request (SR) transmissions to mitigate thermal or battery state and extend operation of the UE on the battery charge. By reducing the effective rate of the SR transmissions of the UE in response to particular thermal or battery conditions, the present solution can allow the UE to mitigate the thermal buildup in the UE as well as reduce the rate at which the battery is being discharged, while allowing for the SR transmissions to be completed at an effectively lower periodicity.

In some aspects, the present solution relates to a method. The method can include receiving, by a wireless communication device, a configuration to transmit a plurality of scheduling requests (SRs) for uplink wireless communication in accordance with a periodicity. The periodicity can be defined by a plurality of time intervals. The method can include identifying, by the wireless communication device, a state indicative of at least one of a thermal or a battery condition of the wireless communication device. The method can include determining, by the wireless communication device in response to the identified state, to delay transmission of a first SR of the plurality of SRs for at least a first time interval of the plurality of time intervals. The method can include transmitting, by the wireless communication device, the first SR at a second time interval of the plurality of time intervals in accordance with the determining.

The method can include identifying, by the wireless communication device, the thermal condition corresponding to a circuit used for the uplink wireless communication. The method can include detecting, by the wireless communication device, that the thermal condition exceeds a thermal threshold. The method can include determining, by the wireless communication device in response to the thermal condition exceeding the thermal threshold, to delay the transmission of the first SR. In some implementations, detecting that the thermal condition exceeds the thermal threshold corresponds to a determination of at least one of: temperature, heat, electrical current, voltage or power corresponding to the circuit.

The method can include detecting, by the wireless communication device, that the battery condition exceeds a battery threshold. The method can include determining, by the wireless communication device in response to the battery condition exceeding the battery threshold, to delay the transmission of the first SR. In some implementations the detecting that the battery exceeds the battery threshold corresponds to a determination. The determination can be a determination of at least one of: an amount of charge remaining in the battery, a state of charge of the battery, a battery life of the battery, a rate of discharge of the battery or a temperature of the battery.

The wireless communication device can determine to delay the transmission of the first SR by a first amount of time in response to determining that the state is a first state of a plurality of states. The method can include identifying, by the wireless communication device, a second state indicative of at least one of the thermal or the battery condition of the wireless communication device. The method can include determining, by the wireless communication device, to delay transmission of a second SR of the plurality of SRs by a second amount of time in response to the identified second state.

The method can include determining, by a modem of the wireless communication device in response to the identified state, to delay transmission of at least one SR of the plurality of SRs for at least the first time interval of the plurality of time intervals. The at least one SR can correspond to at least one application executing on the wireless communication device. The method can include determining, by an application executing on the wireless communication device in response to the identified state, to delay transmission of the first SR of the plurality of SRs for at least the first time interval of the plurality of time intervals. The first SR can correspond to the application.

The method can include identifying, by the wireless communication device, that a first priority is assigned to a first application executing on the wireless communication device. The method can include identifying, by the wireless communication device, that a second priority is assigned to a second application executing on the wireless communication device. The method can include determining, by the wireless communication device in response to the first priority being higher than the second priority, to delay transmission of the first SR for at least the first time interval of the plurality of time intervals. The first SR can correspond to the second application. The method can include transmitting, by the wireless communication device in response to the first priority being higher than the second priority, a second SR of the plurality of SRs corresponding to the first application, at the first time interval. The method can include determining, by a modem of the wireless communication device in response to the identified state, to delay transmission of at least one SR of the plurality of SRs for at least the first time interval of the plurality of time intervals until a buffer threshold is met. The at least one SR can correspond to at least one application executing on the wireless communication device.

In some aspects, the present solution relates to a system. The system can include a wireless communication device comprising at least one processor. The wireless communication device can be configured to receive a configuration to transmit a plurality of scheduling requests (SRs) for uplink wireless communication in accordance with a periodicity defined by a plurality of time intervals. The wireless communication device can be configured to identify a state indicative of at least one of a thermal or a battery condition of the wireless communication device. The wireless communication device can be configured to determine, in response to the identified state, to delay transmission of a first SR of the plurality of SRs for at least a first time interval of the plurality of time intervals. The wireless communication device can be configured to transmit the first SR at a second time interval of the plurality of time intervals in accordance with the determining.

The system can include the wireless communication device that is configured to identify the thermal condition corresponding to a circuit used for the uplink wireless communication. The wireless communication device can be configured to detect that the thermal condition exceeds a thermal threshold. The wireless communication device can be configured to determine, in response to the thermal condition exceeding the thermal threshold, to delay the transmission of the first SR.

The system can include the wireless communication device that detects that the thermal condition exceeds the thermal threshold in response to a determination of at least one of: temperature, heat, electrical current, voltage or power corresponding to the circuit. The wireless communication device can be configured to detect that the battery condition exceeds a battery threshold and determine, in response to the battery condition exceeding the battery threshold, to delay the transmission of the first SR. The wireless communication device can detect that the battery exceeds the battery threshold in response to a determination of at least one of: an amount of charge remaining in the battery, a state of charge of the battery, a battery life of the battery, a rate of discharge of the battery or a temperature of the battery.

The system can include the wireless communication device that determines to delay the transmission of the first SR by a first amount of time in response to determining that the state is a first state of a plurality of states. The wireless communication device can be configured to identify a second state indicative of at least one of the thermal or the battery condition of the wireless communication device and determine to delay transmission of a second SR of the plurality of SRs by a second amount of time in response to the identified second state.

The system can include the wireless communication device that comprises a modem that is configured to determine, in response to the identified state, to delay transmission of at least one SR of the plurality of SRs for at least the first time interval of the plurality of time intervals. The at least one SR can correspond to at least one application executing on the wireless communication device.

The system can include the wireless communication device that is configured to identify that a first priority is assigned to a first application executing on the wireless communication device and a second priority is assigned to a second application executing on the wireless communication device. The wireless communication device can be configured to determine, in response to the first priority being higher than the second priority, to delay transmission of the first SR for at least the first time interval of the plurality of time intervals. The first SR can corresponding to the second application. The wireless communication device can transmit, in response to the first priority being higher than the second priority, a second SR of the plurality of SRs corresponding to the first application, at the first time interval.

The system can include the wireless communication device that comprises a modem that is configured to determine, in response to the identified state, to delay transmission of at least one SR of the plurality of SRs for at least the first time interval of the plurality of time intervals until a buffer threshold is met. The at least one SR can correspond to at least one application executing on the wireless communication device.

In some aspects, the present solution relates to a non-transitory computer readable medium storing program instructions. The program instructions can be for causing at least one processor of a device to receive a configuration to transmit a plurality of scheduling requests (SRs) for uplink wireless communication in accordance with a periodicity defined by a plurality of time intervals. The program instructions can be for identifying a state indicative of at least one of a thermal or a battery condition of the wireless communication device. The program instructions can be for determining, in response to the identified state, to delay transmission of a first SR of the plurality of SRs for at least a first time interval of the plurality of time intervals. The program instructions can be for transmitting the first SR at a second time interval of the plurality of time intervals in accordance with the determining.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram showing example components of a base station and a user equipment, according to an example implementation of the present disclosure.

FIG. 3 is a block diagram of a system for mitigating thermal and/or battery conditions via adjusting a schedule of scheduling requests (SRs) for uplink wireless communication, according to an example implementation of the present disclosure.

FIG. 4 is a plot diagram of an example of adjusting a schedule of SRs for uplink wireless communication, according to an example implementation of the present disclosure.

FIG. 5 is an example of buffers for storing or queuing SRs for uplink wireless communication, according to an example implementation of the present disclosure.

FIG. 6 is a flowchart showing a process of adjusting a schedule of SRs, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

The present disclosure is directed to systems and methods of auto-scaling (e.g., adaptively updating the schedule or periodicity of) scheduling requests (SR) in uplink wireless communications in order to mitigate thermal conditions or a state of a user device or its battery. In wearable or mobile devices, a buildup of heat can occur in the circuitry of a UE, such as for example at a power amplifier of a UE used for uplink communications. The heat can adversely affect the battery of the device. For example, when a user device operates at a higher communication rate, the rate at which SRs are transmitted by the user device can adversely affect both the heat in the device and the rate at which the battery is being discharged. In such situations, if the heat is not properly managed, the performance of the battery and/or the circuitry of the UE can deteriorate. Reducing the average rate at which the SRs are transmitted can help mitigate the heat buildup in the UE circuitry and can reduce the rate at which the device battery is discharged. The SR periodicity at which SRs are transmitted by the UE is usually set by the cellular network and so the UEs normally may not be able to modify their SR periodicity, making it challenging for the UEs to mitigate their heat by controlling SRs.

The present disclosure provides a solution by which a user device (e.g., UE) can reconfigure the periodicity of its uplink transmissions of SRs to mitigate its thermal or battery state of charge conditions. The present solution can modify its effective SR periodicity (e.g., average rate at which SRs are transmitted from the UE) both at the modem level (e.g., for all applications of the user device) and/or at the application level (e.g., for each application individually). The present solution therefore can allow for the applications of lower priority to have their SRs transmitted at a lower effective transmission rate, allowing for high-priority communications, including communication acknowledgements and/or XR traffic, to be communicated at higher effective SR transmission rate/frequency.

More specifically, the present solution allows for a wearable device or a UE that utilizes SRs for wireless communication to receive a network configuration to set the SR periodicity in accordance with defined time intervals. However, the despite the network configuration, the present solution allows for the UE to delay SR transmissions by skipping time intervals of the SR periodicity in response to thermal or battery states thereby reducing the effective SR rate of transmissions in order to mitigate the temperature and/or the battery state of the UE. The present solution can also allow for the UE to delay SR transmissions according to data buffer thresholds, which can be set or configured corresponding to thermal and/or battery levels. The user device can identify, detect or monitor a temperature of a device's circuitry and/or a state of charge of a battery of the user device. The user device can reset or reconfigure the SR periodicity and/or delay a SR transmission, at the modem or one or more applications of the user device to reduce the rate at which RSs are transmitted so as to mitigate the thermal buildup or reduce the rate at which the battery is discharged.

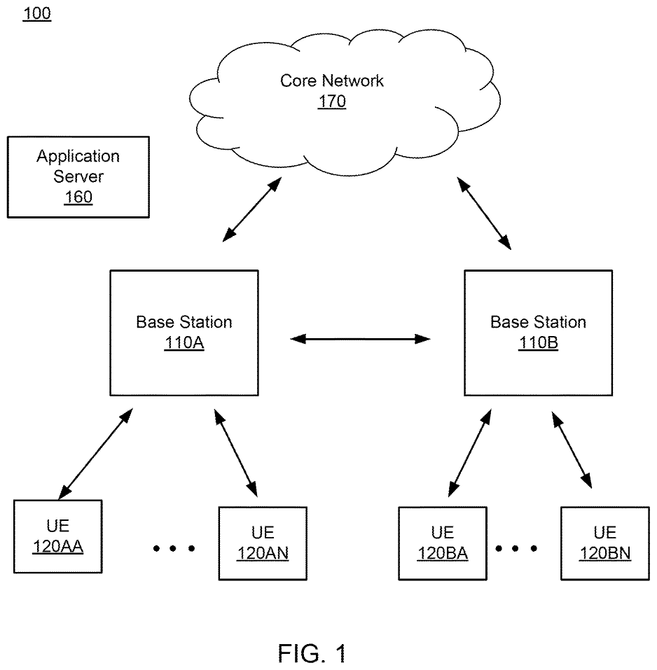

FIG. 1 illustrates an example wireless communication system 100. The wireless communication system 100 may include base stations 110A, 110B (also referred to as “wireless communication nodes 110” or “stations 110”) and user equipments (UEs) 120AA . . . 120AN, 120BA. 120BN (also referred to as “wireless communication devices 120″ or ”terminal devices 120″). The wireless communication link may be a cellular communication link conforming to 3G, 4G, 5G, 6G or other cellular communication protocols. In one example, the wireless communication link supports, employs or is based on an orthogonal frequency division multiple access (OFDMA). In one aspect, the UEs 120AA . . . 120AN are located within a geographical boundary with respect to the base station 110A, and may communicate with or through the base station 110A. Similarly, the UEs 120BA . . . 120BN are located within a geographical boundary with respect to the base station 110B, and may communicate with or through the base station 110B. A network between UEs 120 and the base stations 110 may be referred to as radio access network (RAN). In some embodiments, the wireless communication system 100 includes more, fewer, or different number of base stations 110 than shown in FIG. 1.

In some embodiments, the UE 120 may be a user device such as a mobile phone, a smart phone, a personal digital assistant (PDA), tablet, laptop computer, wearable computing device (e.g., head mounted display, smart watch), etc. Each UE 120 may communicate with the base station 110 through a corresponding communication link. For example, the UE 120 may transmit data to a base station 110 through a wireless communication link (e.g., 3G, 4G, 5G, 6G or other cellular communication link), and/or receive data from the base station 110 through the wireless communication link (e.g., 3G, 4G, 5G, 6G or other cellular communication link). Example data may include audio data, image data, text, etc. Communication or transmission of data by the UE 120 to the base station 110 may be referred to as an uplink communication. Communication or reception of data by the UE 120 from the base station 110 may be referred to as a downlink communication.

In some embodiments, the base station 110 may be an evolved node B (eNB), a gNodeB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations.

In some embodiments, the wireless communication system 100 includes a core network 170. The core network 170 may be a component or an aggregation of multiple components that ensures reliable and secure connectivity to the network for UEs 120. The core network 170 may be communicatively coupled to one or more base stations 110A, 110B through a communication link. A communication link between the core network 170 and a base station 110 may be a wireless communication link (e.g., 3G, 4G, 5G, 6G or other cellular communication link) or a wired communication link (e.g., Ethernet, optical communication link, etc.). In some embodiments, the core network 170 includes user plane function (UPF), access and mobility management function (AMF), policy control function (PCF), etc. The UPF may perform packet routing and forwarding, packet inspection, quality of service (QOS) handling, and provide external protocol data unit (PDU) session for interconnecting data network (DN). The AMF may perform registration management, reachability management, connection management, etc. The PCF may help operators (or operating devices) to easily create and seamlessly deploy policies in a wireless network. The core network 170 may include additional components for managing or controlling operations of the wireless network. In one aspect, the core network 170 may receive a message to perform a network congestion control, and perform the requested network congestion control. For example, the core network 170 may receive explicit congestion notification (ECN) from a base station 110 and/or a UE 120, and perform a network congestion control according to the ECN. For example, the core network 170 may adjust or control an amount of data generated, in response to the ECN. Additionally or alternatively, the core network 170 may adjust or control an amount of data transmitted and/or received, in response to the ECN.

In some embodiments, the wireless communication system 100 includes an application server 160. The application server 160 may be a component or a device that generates, manages, or provides content data. The application server 160 may be communicatively coupled to one or more base stations 110A, 110B through a communication link. A communication link between an application server 160 and a base station 110 may be a wireless communication link (e.g., 3G, 4G, 5G, 6G or other cellular communication link) or a wired communication link (e.g., Ethernet, optical communication link, etc.). In one aspect, an application server 160 may receive a request for data from a UE 120 through a base station 110, and provide the requested data to the UE 120 through the base station 110. In one aspect, an application server 160 may receive a message to perform a network congestion control, and perform the requested network congestion control. For example, the application server 160 may receive explicit congestion notification (ECN) from a base station 110, a UE 120, or a core network 170, and perform a network congestion control according to the ECN. For example, the application server 160 may adjust or control an amount of data generated, in response to the ECN. Additionally or alternatively, the application server 160 may adjust or control an amount of data transmitted and/or received, in response to the ECN. Additionally or alternatively, the application server 160 may adaptively adjust or control an error correct rate. An error correction rate may be a rate of a number of error correction packets (also referred to as “protection packets”) per a set of packets for transmission. An error correction packet can be provided to help recover content. The application server 160 may adaptively adjust the error correction rate, according to a signal quality of a signal received by a UE 120 or a location of the UE 120 with respect to one or more base stations 110.

In some embodiments, communication among the base stations 110, the UEs 120, application server 160, and the core network 170 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

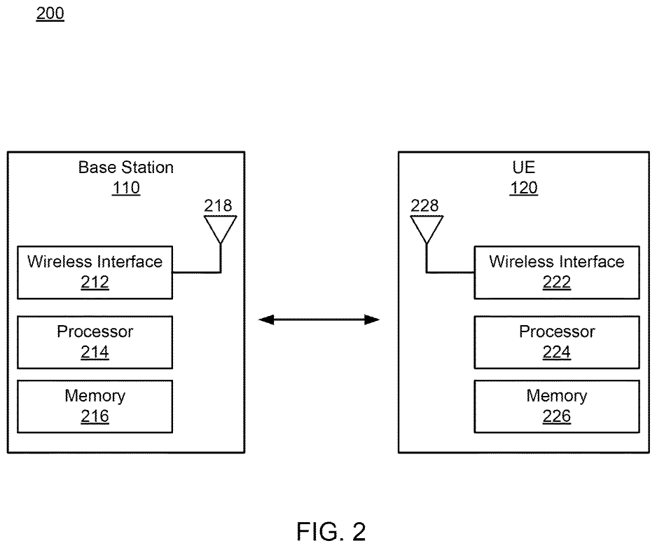

FIG. 2 is a diagram showing example components of a base station 110 and a user equipment 120, according to an example implementation of the present disclosure. In some embodiments, the UE 120 includes a wireless interface 222, a processor 224, a memory device 226, and one or more antennas 228. These components may be embodied as hardware, software, firmware, or a combination thereof. In some embodiments, the UE 120 includes more, fewer, or different components than shown in FIG. 2. For example, the UE 120 may include an electronic display and/or an input device. For example, the UE 120 may include additional antennas 228 and wireless interfaces 222 than shown in FIG. 2.

The antenna 228 may be a component that receives a radio frequency (RF) signal and/or transmits a RF signal through a wireless medium. The RF signal may be at a frequency between 200 MHz to 100 GHz. The RF signal may have packets, symbols, or frames corresponding to data for communication. The antenna 228 may be a dipole antenna, a patch antenna, a ring antenna, or any suitable antenna for wireless communication. In one aspect, a single antenna 228 is utilized for both transmitting a RF signal and receiving a RF signal. In one aspect, different antennas 228 are utilized for transmitting the RF signal and receiving the RF signal. In one aspect, multiple antennas 228 are utilized to support multiple-in, multiple-out (MIMO) communication.

The wireless interface 222 includes or is embodied as a transceiver for transmitting and receiving RF signals through one or more antennas 228. The wireless interface 222 may communicate with a wireless interface 212 of the base station 110 through a wireless communication link. In one configuration, the wireless interface 222 is coupled to one or more antennas 228. In one aspect, the wireless interface 222 may receive the RF signal at the RF frequency received through an antenna 228, and downconvert the RF signal to a baseband frequency (e.g., 0˜1 GHz). The wireless interface 222 may provide the downconverted signal to the processor 224. In one aspect, the wireless interface 222 may receive a baseband signal for transmission at a baseband frequency from the processor 224, and upconvert the baseband signal to generate a RF signal. The wireless interface 222 may transmit the RF signal through the antenna 228.

The processor 224 is a component that processes data. The processor 224 may be embodied as field programmable gate array (FPGA), application specific integrated circuit (ASIC), a logic circuit, etc. The processor 224 may obtain instructions from the memory device 226, and execute the instructions. In one aspect, the processor 224 may receive downconverted data at the baseband frequency from the wireless interface 222, and decode or process the downconverted data. For example, the processor 224 may generate audio data or image data according to the downconverted data, and present an audio indicated by the audio data and/or an image indicated by the image data to a user of the UE 120. In one aspect, the processor 224 may generate or obtain data for transmission at the baseband frequency, and encode or process the data. For example, the processor 224 may encode or process image data or audio data at the baseband frequency, and provide the encoded or processed data to the wireless interface 222 for transmission.

The memory device 226 is a component that stores data. The memory device 226 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 226 may be embodied as a non-transitory computer readable medium storing instructions executable by the processor 224 to perform various functions of the UE 120 disclosed herein. In some embodiments, the memory device 226 and the processor 224 are integrated as a single component.

In some embodiments, the base station 110 includes a wireless interface 212, a processor 214, a memory device 216, and one or more antennas 218. These components may be embodied as hardware, software, firmware, or a combination thereof. In some embodiments, the base station 110 includes more, fewer, or different components than shown in FIG. 2. For example, the base station 110 may include an electronic display and/or an input device. For example, the base station 110 may include additional antennas 218 and wireless interfaces 212 than shown in FIG. 2.

The antenna 218 may be a component that receives a radio frequency (RF) signal and/or transmits a RF signal through a wireless medium. The antenna 218 may be a dipole antenna, a patch antenna, a ring antenna, or any suitable antenna for wireless communication. In one aspect, a single antenna 218 is utilized for both transmitting a RF signal and receiving a RF signal. In one aspect, different antennas 218 are utilized for transmitting the RF signal and receiving the RF signal. In one aspect, multiple antennas 218 are utilized to support multiple-in, multiple-out (MIMO) communication.

The wireless interface 212 includes or is embodied as a transceiver for transmitting and receiving RF signals through one or more antennas 218. The wireless interface 212 may communicate with a wireless interface 222 of the UE 120 through a wireless communication link. In one configuration, the wireless interface 212 is coupled to one or more antennas 218. In one aspect, the wireless interface 212 may receive the RF signal at the RF frequency received through antenna 218, and downconvert the RF signal to a baseband frequency (e.g., 0˜1 GHz). The wireless interface 212 may provide the downconverted signal to the processor 214. In one aspect, the wireless interface 212 may receive a baseband signal for transmission at a baseband frequency from the processor 214, and upconvert the baseband signal to generate a RF signal. The wireless interface 212 may transmit the RF signal through the antenna 218.

The processor 214 is a component that processes data. The processor 214 may be embodied as FPGA, ASIC, a logic circuit, etc. The processor 214 may obtain instructions from the memory device 216, and execute the instructions. In one aspect, the processor 214 may receive downconverted data at the baseband frequency from the wireless interface 212, and decode or process the downconverted data. For example, the processor 214 may generate audio data or image data according to the downconverted data. In one aspect, the processor 214 may generate or obtain data for transmission at the baseband frequency, and encode or process the data. For example, the processor 214 may encode or process image data or audio data at the baseband frequency, and provide the encoded or processed data to the wireless interface 212 for transmission. In one aspect, the processor 214 may set, assign, schedule, or allocate communication resources for different UEs 120. For example, the processor 214 may set different modulation schemes, time slots, channels, frequency bands, etc. for UEs 120 to avoid interference. The processor 214 may generate data (or UL CGs) indicating configuration of communication resources, and provide the data (or UL CGs) to the wireless interface 212 for transmission to the UEs 120.

The memory device 216 is a component that stores data. The memory device 216 may be embodied as RAM, flash memory, ROM, EPROM, EEPROM, registers, a hard disk, a removable disk, a CD-ROM, or any device capable for storing data. The memory device 216 may be embodied as a non-transitory computer readable medium storing instructions executable by the processor 214 to perform various functions of the base station 110 disclosed herein. In some embodiments, the memory device 216 and the processor 214 are integrated as a single component.

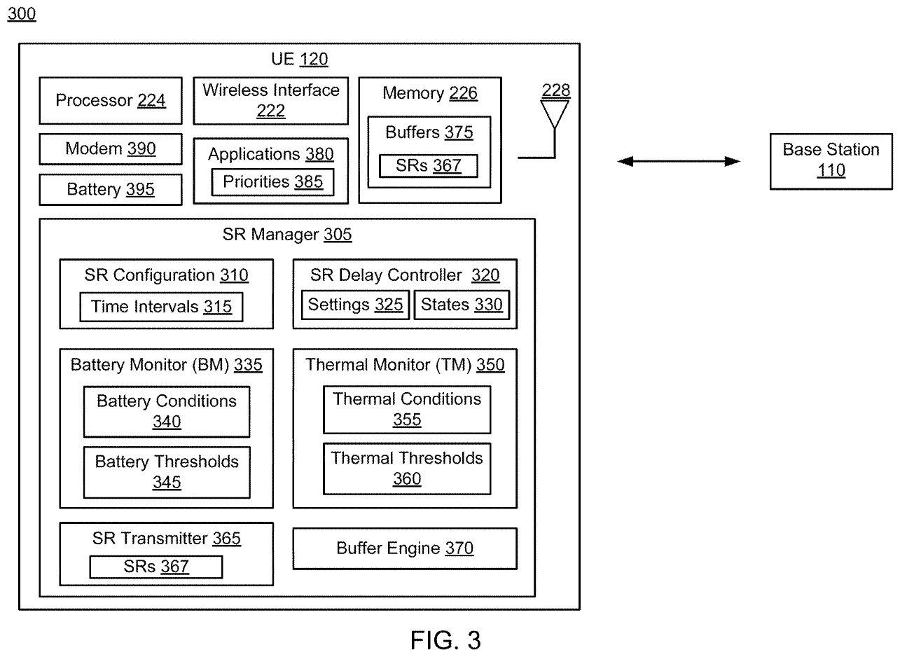

FIG. 3 depicts an example of a system 300 in which a user equipment (UE) 120 is configured to delay or offset transmission of scheduling requests (SRs) 367 for uplink wireless communication in order to mitigate thermal or battery conditions. A UE 120 can include one or more processors 224, one or more wireless interfaces 222, one or more antennas 228 and/or one or more batteries 395, which the UE 120 can use for its operation and for network communication with one or more base stations 110. UE 120 can also include memory 226 which can include buffers 375 having (e.g., queuing or holding) SRs 367, a modem 390 and one or more SR managers 305. An SR manager 305 can include one or more SR delay controllers 320, one or more battery monitors (BM) 335, one or more thermal monitors (TM) 350, one or more SR transmitters 365 for transmitting SRs 367, one or more buffer engines 370 and one or more SR configurations 310 that can include one or more time intervals 315. An SR delay controller 320 can include one or more settings 325 and can detect or operate on one or more states 330. A BM 335 can include one or more battery conditions 340 and can include/maintain one or more battery thresholds 345 (e.g., for use/comparison/monitoring). A TM 350 can include (e.g., store, monitor for) one or more thermal conditions 335 and one or more thermal thresholds 360.

At a high level, FIG. 3 can relate to a system 300 in which a UE 120 can utilize the processor 224, wireless interface 222, memory 226, modem 390 and/or antenna 228 to implement wireless communication with the base station 110. The UE 120 can receive from the base station 110 an SR configuration 310 defining the periodicity at which SRs 367 are to be transmitted by the UE 120 during uplink communications and where the periodicity can be defined by, or correspond to, one or more time intervals 315. Meanwhile, an SR manager 305 can utilize a BM 335 and a TM 350 to monitor and detect one or more battery conditions 340 or thermal conditions 355 based on which determinations can be made on whether the battery or thermal thresholds 345 and 360 have been passed or exceeded. When the BM 335 or TM 350 determines that a battery threshold 345 or thermal threshold 360 is exceeded, SR delay controller 320 can determine the state 330 that corresponds to conditions 340 or 355 with respect to their exceeded or passed thresholds 345 or 360. SR delay controller 320 can then determine the settings 325 for the SR transmissions so as to create a new effective SR transmission rate (e.g., a new effective periodicity with new effective time intervals for SR transmissions) that is different from the transmission rate or periodicity established by the SR configuration 310 in accordance with configured time intervals 315. Therefore, by transmitting SRs 367 based on the settings 325 that modify (e.g., reduce) the effective SR transmission rate (e.g., at a lower frequency rate and higher effective time interval between SR transmissions), despite the SR configuration 310 configuring SR transmissions at time intervals 315, the system 300 can mitigate, address or improve the thermal or battery conditions 340 and 355. The system 300 can mitigate/improve the thermal or battery conditions 340 or 355 by delaying or skipping SR transmissions at time intervals 315 or by utilizing the buffer engine 370 to manage buffers 375 for various states 330 or applications 380 and transmit the SRs 367 from those buffers 375 when thresholds for buffers 375 are reached or exceeded.

An SR 367 can be any physical layer message for a UE 120 to request from a network (e.g., base station 110) to send UL grant (e.g., DCI format 0) so that UE 120 can send PUSCH transmissions. SR 367 can include an uplink physical layer message from UE 120 to the network (e.g., base station 110) indicating to the network that UE 120 has some data to transmit. The rate at which SRs 367 are transmitted by the UE 120 can determine the rate at which UE 120 can work to transmit the data. Accordingly, the faster SRs 367 are transmitted, the more thermal energy and battery charge can be utilized by the UE 120.

Scheduling request (SR) manager 305 can be any combination of hardware and software for managing scheduling requests (SRs) 367. SR manager 305 can include any combination of functions, computer code, instructions, commands, executables, applications or programs that can be executed on hardware circuit(s), such as a processor or an integrated analog or digital circuit. SR manager 305 can determine, manage, schedule and/or implement transmissions of SRs 367 for wireless communication, including controlling the effective rate at which SRs 367 are transmitted. For example, the effective rate at which SRs 367 are transmitted can include rates that can be created by skipping transmissions on particular scheduled time interval, such for example when SRs 367 are transmitted at every other configured time interval, or every third time interval, or so that every second and/or every third time interval is the one for which SR transmissions are skipped. SR manager 305 can monitor or manage SR transmissions for a variety of applications 380, including depending on their priorities 385. SR manager 305 can manage the rate of transmissions per individual application 380 or for all applications per modem 390 via which SRs 367 are transmitted.

Scheduling request (SR) configuration 310 can be any configuration for setting the rate or time intervals at which SRs 367 are to be transmitted by UE 120. SR configuration 310 can be received by the UE 120 from the base station 110 or some other controller of the network via which UE 120 is communicating. SR configuration 310 can include a configuration by which the periodicity (e.g., period or any other setting defining the rate) of the SR transmissions is defined, set or configured.

The periodicity at which SRs 367 are to be transmitted can be defined by time intervals or periods, such as time intervals 315 (e.g., each of which separates one SR transmission from a next SR transmission, or each of which covers an SR transmission). A time interval 315 can include a length of time by which the periodicity or the rate at which SRs 367 are to be transmitted by the UE 120 can be defined per SR configuration 310. For example, periodicity can be defined by setting a time interval at any time duration, such as any time duration between 1 and 200 milliseconds (ms), such as 5 ms, 10 ms, 20 ms, 40 ms, 80 ms, 160 ms or more than 200 ms. For example, when time interval 315 is set at 10 ms, the subframe offset for the SR can be offset by 5 ms and when time interval 315 is set at 20 ms, the subframe offset for the SR can be offset by 15 ms. For example, if a higher layer is configured with a configuration index of 6 ms, then for each sub-frame with 10 ms periodicity the UE can transmit SR request to an eNB on a network and the eNB can grant a resource to UE after 4 ms of SR transmission.

Battery monitor (BM) 335 can include any combination of hardware and software for monitoring the condition or state of a battery 395. A BM 335 can monitor, observe, detect or determine battery conditions 340 and can detect or determine whether any of the battery conditions 340 exceed any of the battery thresholds 345. A BM 335 can include any combination of functions, computer code, instructions, commands, executables, applications or programs that can be executed on a hardware circuit, such as a processor or an integrated, analog or a digital circuit to monitor the battery 395 and can determine its conditions 340 with respect to one or more battery thresholds 345. A BM 335 can include, utilize or communicate with sensors, detectors or circuits for monitoring any battery conditions 340 or determining whether any battery thresholds 345 were exceeded or passed.

A battery 395 can include any device for storing electrical charge or energy, such as a lithium ion battery, a solid state battery, a nickel-cadmium battery or any other energy storage device. Since a battery 395 can dissipate its charge at a particular rate, including for example also passing a particular battery threshold 345 for the rate of charge remaining, the BM 335 can detect that the battery 395 has dissipated its charge past a threshold, such as a battery threshold 345 that can correspond to a low amount of remaining charge, or a state of charge, rate at which the charge is being dissipated, a (remaining) battery life at a temperature of the battery 395.

Battery conditions 340 can include any condition or state of a battery 395. For example, battery condition 340 can include or correspond to an amount of charge remaining in the battery 396, a state of charge (SOC) of the battery 395, a battery life of the battery 395, a rate of discharge of the battery 395 or a temperature of the battery 395. Battery condition 340 can include or correspond to an amount of time for which the UE 120 will remain powered unless the battery 390 is recharged. A battery condition 340 can be determined or estimated based on the present state of charge or amount of charge at the battery 390 or a rate at which the charge at the battery 390 is changing. Battery condition 340 can be or correspond to any condition or a state corresponding to a battery 395 that BM 335 monitors, observes, detects, identifies or determines.

Battery thresholds 345 can include any thresholds or limits for or corresponding to any battery condition 340. For example, battery threshold 345 can include a threshold or a limit for an amount of charge remaining at the battery 396. Battery threshold 345 can include a threshold or a limit for a state of charge (SOC) of the battery 395, a battery life of the battery 395, a rate of discharge of the battery 395 or a temperature of the battery 395. Battery threshold 345 can include a threshold or a limit for the amount of time for which UE 120 will remain powered unless the battery 390 is recharged. Battery threshold 345 can be a predetermined threshold 345. Battery threshold 345 can be a threshold determined or set by the BM 335.

Thermal monitor (TM) 350 can be or include any combination of hardware and software for monitoring thermal condition or state on the UE 120, such as a circuit, processor, power amplifier, controller or any other part of the UE 120. A TM 350 can monitor, observe, detect or determine thermal conditions 355 and can detect or determine whether any of the thermal conditions 355 exceed any of the thermal thresholds 360. A TM 350 can include any combination of functions, computer code, instructions, commands, executables, applications or programs that can be executed on a hardware circuit, such as a processor or an integrated, analog or a digital circuit to monitor or determine thermal conditions 355 with respect to one or more thermal thresholds 360. A TM 350 can include, utilize or communicate with sensors, detectors or circuits for monitoring thermal conditions 355, such as temperature, heat or rise of heat or temperature and for determining whether any thermal thresholds 360 were exceeded or passed by any portion of the UE 120

Thermal conditions 355 can include any condition or state relating to thermal energy in or produced by/in the UE 120. For example, thermal condition 355 can include or correspond to a temperature of a circuit, such as a power amplifier, an integrated circuit, a power converter, a power supply or a battery 390. Thermal condition 355 can include or correspond to heat, thermal dissipation, thermal buildup, a rate of rise of thermal energy, a rate of rise of temperature or any other condition or state that relates to or corresponds to thermal state of a circuit or a device. Thermal condition 355 can include or correspond to electrical current, voltage or power corresponding to a circuit or a component of UE 120, such as current, voltage or power consumed, dissipated, consumed or drawn. Thermal condition 355 can include or correspond to a change in current, voltage, or power being drawn or used by a circuit, component or a device as it relates to heat or thermal buildup. A thermal condition 355 can be determined or estimated based on the present temperature reading, power consumption, sensor or detector reading or any other thermal related feature that the TM 350 can monitor, observe, detect identify or determine.

Thermal thresholds 360 can include any thresholds or limits for or corresponding to any thermal condition 355. For example, thermal threshold 360 can include a threshold or a limit for a temperature of a circuit, such as a temperature limit of a power amplifier, integrated circuit, system on a chip (SoC), a processor, a controller or any other component of a UE 120. Thermal threshold 360 can include a threshold or a limit for thermal energy, heat buildup, a rate of rise of thermal energy, a rate of rise of temperature, or any other condition or state that can relate to or correspond to heat. Thermal threshold 360 can include a threshold or a limit that corresponds to a current, voltage or power of a particular circuit, component or part of UE 120. Thermal threshold 360 can include a threshold or a limit for a rate at which current, voltage or power is being dissipated or a rate of rise of voltage, power or current is being drawn by a component. Thermal threshold 360 can be a predetermined threshold 360. Thermal threshold 360 can be a threshold determined or set by the TM 350.

Scheduling request (SR) delay controller 320 can include any combination of hardware and software for controlling delays, offsets or reduction of SR transmissions by UE 120. SR delay controller 320 can include any combination of functions, computer code, instructions, commands, executables, applications or programs that can be executed on a hardware circuit, such as a processor or an integrated, analog or a digital circuit. SR delay controller 320 can determine the reduced periodicity or effective rate at which SRs 367 are to be transmitted by UE 120 in order to mitigate thermal or battery conditions or states. For example, SR delay controller 320 can determine that a battery or a thermal condition 340 or 355 corresponds to a state 330 that is that is high or at a particular level. SR delay controller 320 can, in response to this determination, identify or establish a delay setting 325 at which to transmit SRs 367 in order to address a higher state 330 that corresponds to or is indicative of the thermal battery conditions 340 or 355.

States 330 can include or correspond to any state or level of adjustment of the SR transmission that can be related to, indicative of, or correspond to the battery condition 340 or the thermal condition 355. States 330 can include or correspond to the amount, rate or magnitude at which battery condition 340 or a thermal condition 355 exceeds its corresponding battery threshold 345 or thermal threshold 360. For example, state 330 can be indicative of the magnitude by which the battery threshold 345 or thermal threshold 360 is exceeded. State 330 can correspond to, or indicate, the level of adjustment or reduction of the effective rate at which SRs 367 are to be transmitted by the UE 120 with respect to the time interval 315 provided by SR configuration 310. For instance, when state 330 is higher, a larger delay or a greatly reduced effective rate for SR transmissions is to be created (e.g., greater delay settings 325) by the SR delay controller 320. For instance, when state 330 is lower, a smaller delay or a mildly reduced effective rate for SR transmissions is to be created (e.g., smaller delay settings 325) by the SR delay controller 320.

Settings 325 can refer to any setting for a delay of SR transmission(s) with respect to the time interval 315 from the SR configuration 310. For example, setting 325 can include a setting or a configuration by which SRs 367 are to be transmitted every other time interval 315. In such an instance, setting 325 can correspond to two times the time interval 315, which can correspond to an effective SR transmission rate that is a half of the SR transmission rate per time interval 315 configured by the base station 110. For example, setting 325 can include a setting or a configuration by which SRs 367 are to be transmitted every third time interval 315. In such an instance, setting 325 can correspond to three times the time interval 315, which can correspond to an effective SR transmission rate that is ⅓ of the SR transmission rate per time interval 315 configured by the base station 110. Setting 325 can be larger for a higher state 330. Setting 325 can be lower for a lower state 330. In some implementations, setting 325 can be lower for a higher state 330 or higher for a lower state 330.

SR transmitter 365 can include any combination of hardware and software for transmitting SRs 367. SR transmitter 365 can include any instructions, commands, computer code or executables that can be processed by a processor or an integrated circuit. SR transmitter can include, be connected to or utilize a circuit, such as a power amplifier, or an antenna. SR transmitter 365 can be connected with or utilize one or more buffers 375 from which SRs 367 can be transmitted. SR transmitter 365 can implement the effective rate (e.g., reduced rate or increased effective time interval) at which SRs 367 are transmitted per settings 325 and as established by SR delay controller 320.

Buffer engine 370 can include any combination of hardware and software for controlling buffers 375, or thresholds for a buffer 375. Buffer engine 370 can establish buffers 375 for a variety of applications 380. Buffer engine 370 can establish buffers 375 for applications 380 based on their priorities 385. Buffer sizes or thresholds for storing SRs 367 can be established by buffer engine 370 depending on the settings 325. For example, when a setting 325 is such that a longer time interval is established for transmitting delayed SRs 367, then a larger buffer 375 can be used to handle SRs 367. This can be done, for example, for lower priority 385 applications 380. For example, when a setting 325 is such that time interval 315 is used (e.g., no delays of SR transmissions), then a shorter buffer 375 can be used to handle SRs 367. This can be done, for example, for higher priority 385 applications 380.

Buffers 375 can refer to any memory or data buffer for storing SRs 367. Buffer 375 can include a memory buffer register (MBR) or memory data register (MDR) in a processor or a central processing unit for storing data that is being transferred to and from the immediate access storage. Buffers 375 can be utilized for storing (e.g., maintaining, holding, queuing) SRs 367 prior to SRs 367 being transmitted by the UE 120 and can be emptied when the buffer 375 are filled or reach their memory threshold. Buffers 375 can refer to allocated memory ranges for various types of SRs 367, based on their priority 385, their settings 325 or their states 330. For example, when SRs 367 are a lower priority 385 or have larger delay settings 325 or correspond to high states 330 (e.g., or levels of adjustment to address the thermal or battery conditions), then SRs 367 can be assigned a larger memory range. This larger memory range can take a longer time to fill up and so these SRs 367 can take longer to transmit. For example, when SRs 367 are a higher priority 385, or have lower delay settings 325 or their states 330 are lower (e.g., levels of adjustment to address the thermal or battery conditions call for smaller delays) then, buffers 375 can be smaller (e.g., ranges of memory can be smaller) so that the buffers 375 can fill out faster and the corresponding SRs 367 can be transmitted more often.

Buffers 375 can also include a time limit or buffer temporal threshold by which buffers 375 have to be emptied even if they are not filled. For example, a buffer 375 for a lower priority application 380 can include SRs 367 which can be delayed by a longer time period (e.g., have a higher delay setting 325). As SRs 367 are being added to such a buffer 375, a time limit for this buffer 375 can expire, at which point the buffer 375 can be emptied and all SRs 367 can be transmitted from the buffer 375 even if the buffer is not filled or its memory threshold was not reached.

Applications 380 can include any applications executing on a UE 120. Application 380 can include any application generating SRs 367 or an application for which SRs 367 are generated and transmitted. Application 380 can include an application, such as a web browser, video or audio streaming application, email application, a remote access application or any other application which can use or can correspond to one or more SRs 367 to be transmitted by the UE 120.

Priorities 385 can be assigned for any application 380. For example, a first application 380 can be assigned a high priority, while a second application 380 can be assigned a low priority. In such an instance, the first application 380 that was assigned a high priority 385 may be not delayed, while the second application that is assigned a low priority can be delayed by the SR delay controller 320, such as by establishing or providing a setting 325 by which SRs 367 of this application can be transmitted on every 2^{nd} or every 3^{rd} or every 4^{th} fourth SR configured time interval 315. Any number of priorities 385 can be assigned for applications 380, such as any number or ranks of priorities, such as first, second, third, fourth and so on. Each of the priorities 385 can correspond to a different delay setting 325 or a different state 330 for which thermal and/or battery conditions can be adjusted.

Modem 390 can include any combination of hardware and software for converting/processing data for transmission, such as to support transmitting SRs 367 from the UE 120. Modem 390 can include or correspond to any modulator-demodulator circuit, which can include a device for converting transmissions or data, including SRs 367, from a digital format into a format suitable for an analog transmission medium such as a wireless radio. Modem 390 can include a component of UE 120 and can be connected to an antenna 228. Modem 390 can include or be connected to the SR manager 305 and can implement SR transmissions as determined by the SR delay controller 320. Modem 390 can be coupled with or in communication with a transceiver for transmitting and receiving data.

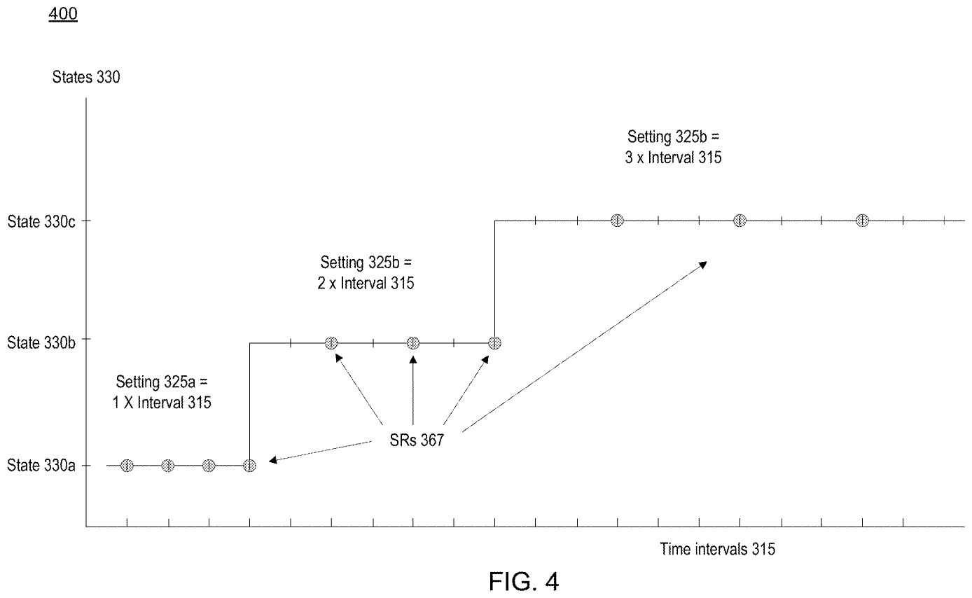

FIG. 4 relates to a graph 400 in which states 330 are graphed with respect to time intervals 315 in order to show various settings 325 based on the time intervals 315 and states 330. Graph 400 includes time intervals 315 on an x-axis and states 330 on y-axis. At state 330a, no delay of SR transmissions may occur and SR transmissions can occur at time interval 315, in accordance with SR configuration 310. Therefore, at state 330a, a corresponding setting 325a may include or cause no delay beyond configured SR transmissions at time intervals 315.

At state 330b, SR transmissions can occur at every other time interval 315. For example, at state 330b, a setting 325b can cause an SR transmission at a first time interval 315 to be delayed so that SR transmissions can be transmitted at the next time interval 315 (e.g., SR transmissions are skipping every other time interval 315). In such a configuration, setting 325b can cause the effective rate of SR transmissions to be at half of the frequency of the original frequency configured by SR configuration 310, or stated differently, have an effective SR transmission time interval that is twice the original time interval 315.

At state 330c, SR transmissions can occur at every third time interval 315. For example, at state 330c, a setting 325c can cause an SR transmission at a first time interval 315 and at a second time interval 315 to be delayed so that SR transmissions can be transmitted at the next (e.g., third) time interval 315. In this configuration, SR transmissions can skip two time intervals 315 and transmit SR transmissions at every third time interval 315. A setting 325c can cause the effective rate of SR transmissions to be at a third of the frequency of the original frequency configured by SR configuration 310, or stated differently, have an effective SR transmission time interval that is three times the original time interval 315.

As shown in FIG. 4, different states 330 can correspond to different delay settings 325 and result in different effective time intervals at which SRs 367 are to be transmitted. While illustrated examples in FIG. 4 show 2× and 3× time interval examples, it is understood that state 330 can be set at any setting 325, such as for example 1.5 time interval 315, in which two transmissions can be sent during three time intervals 315. Likewise, state 330 can be set at a setting 325 so as to send any fraction of setting 325 initial interval 315 within a time period of any length, such as ⅛, 1/7, ⅙, ⅕, ¼, ⅓, ½, ⅔, ¾, ⅘, ⅚, ⅞ or any other fraction. As states 330 can be selected or determined based on the thermal and/or battery conditions 340 or 355 and the amount by which they pass or exceed their corresponding thresholds 345 or 360, settings 325 can be set up to correspond to the states 330 that in turn correspond to, or are indicative of, the rate at which the thresholds are exceeded.

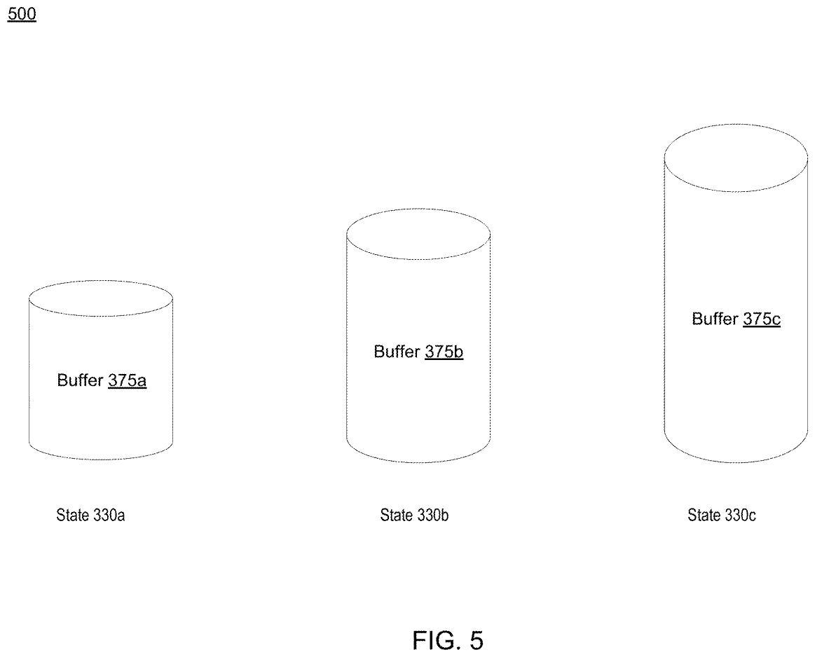

FIG. 5 illustrates an example 500 of a buffer-based implementation of delayed SR transmission in which one or more buffers 375, such as three buffers 375 in the illustrated example (e.g., buffer 375a, 375b and 375c) can be established. The buffers 375 can be based on states 330, such as states 330a, 330b and 330c. Each of the buffers 375a, 375b and 375c can include any feature or functionality of a buffer 375 or buffer ranges stored in a memory 226.

Buffers 375a-c can receive, store and accumulate the SRs 367 that correspond to each of the buffers 375a-c until each of the buffers 375a-c is filled or until their respective thresholds are reached. Once the threshold for the buffers 375a-c are reached, SRs 367 stored in each of the respective buffers 375a-c can be sent for transmission based on when the corresponding buffer (e.g., 375a, 375b or 375c) has reached its threshold. For example, buffer 375c, which is larger than buffer 375a, can store more SRs 367 and therefore can take a longer time to reach its threshold, thereby being emptied less often than the buffer 375a. As such, buffer 375c can store SRs 367 that can be delayed longer (e.g., SRs for low priority applications, such as background applications) than SRs 367 stored in buffer 375a (e.g., which can correspond to high priority applications or communication transmissions that cannot be delayed).

For example, state 330a can correspond to a buffer 375a, and the buffer 375a can correspond to an instance in which SR transmissions are not delayed. Buffer 375a can include data that cannot be delayed, such as for example, network communication instructions or data of/for high priority applications. State 330b can correspond to a buffer 375b, which can be larger than buffer 375a, and which can accumulate SRs 367 for medium priority 385 applications 380. State 330c can correspond to a buffer 375c, which can be larger than buffers 375b and 375a, and which can accumulate SRs 367 for low priority 385 applications 380. When SR transmissions are based on the buffers 375, the size of the buffers 375 can determine the effective rate at which SRs 367 from those buffers 375 are transmitted. SRs 367 in larger buffers can, on average, take a longer time to transmit than SRs 367 in smaller buffers.

Each of the buffers 375a-c can have its own temporal threshold by which the SRs 367 should be emptied (e.g., sent) from the buffer 375. For example, if a buffer 375 reaches its capacity threshold (e.g., is filled up) prior to the temporal threshold, the buffer 375 should have its SRs 367 sent at the next time interval 315. If the buffer 375 reaches its temporal threshold before the buffer 375 reaches its capacity, the SR manager 305 can empty the buffer 375 at the next time interval 315 despite the buffer 375 not reaching its capacity threshold.

In some aspects, the present solution can relate to a wireless communication device, such as a UE 120. The wireless device can be a mobile device or a HWD. The wireless communication device can include at least one processor 224. Processor 224 can be configured to perform functions via instructions that can be stored in memory 226. The processor 224 can be configured to receive, via a transceiver, an SR configuration 310. The SR configuration 310 can include settings or instructions to configure a rate or scheduling of transmissions of a plurality of scheduling requests (SRs 367) for uplink wireless communication in accordance with a periodicity or rate. The periodicity or rate can be defined according to a plurality of time intervals 315. Each time interval 315 can be a particular time period or a time duration, such as 5 ms, 10 ms, 20 ms, 40 ms or 80 ms. The processor 224 can identify a state 330. The state 330 can correspond to or be indicative of at least one of a thermal (e.g., 355) or a battery (e.g., 340) condition of the wireless communication device. For example, the state 330 can indicate that a particular circuit in a device is being heated beyond a threshold rate or amount or that a battery of the device is being discharged at a rate that exceeds a threshold or has a remaining amount of charge that is less than a threshold. The processor 224 can determine, in response to the identified state 330, to delay transmission of a first SR 367 of the plurality of SRs 367 for at least a first time interval 315 of the plurality of time intervals 315. For example, the processor 224 can determine to delay the first SR 376 by one time interval 315 duration, two time intervals 315 duration, three time interval 315 duration or by a variation of time intervals which over time can establish delays that average to a fraction of a selection of time intervals 315 over a period of time. For example, the processor 224 can delay one or more SRs 376 by different amounts over a period of a plurality of time intervals 315 so that the average rate of transmissions over the plurality of timer intervals 315 is a fraction of a time interval, such as ⅓, ⅔, ¾, ⅘, ⅗, 5/7, 6/7, ⅞ or any other fraction of the time interval 315. The processor 224 can transmit, via the transceiver, the first SR 367 at a second time interval 315 of the plurality of time intervals 315 in accordance with the determining.

The processor 224 can be configured to identify the thermal condition corresponding to a circuit used for the uplink wireless communication. The processor 224 can detect that the thermal condition 335 exceeds a thermal threshold. The processor 224 can determine, in response to the thermal condition 335 exceeding the thermal threshold 360, to delay the transmission of the first SR 367. The thermal condition 355 can be indicative of at least one of: temperature, heat, electrical current, voltage or power, corresponding to the circuit. For example, the thermal condition can be indicative of a rate at which the temperature or the heat is increasing in a particular circuit, such as a power amplifier, of a wireless communication device. The thermal condition can be detected based on an amount or a rate of change of a current or power in a circuit. The thermal condition can be detected based on a sensor reading, such as a reading of a temperature sensor.

The processor 224 can be configured to detect that the battery condition 340 passes a battery threshold 345. The processor 224 can determine, in response to the battery condition 340 passing the battery threshold 345, to delay the transmission of the first SR 367. The battery condition 340 can be indicative of at least one of: an amount of charge remaining in the battery, a state of charge of the battery, a battery life of the battery, a rate of discharge of the battery or a temperature of the battery. For example, the battery condition 340 can be determined based on an amount of charge remaining in the battery and a determination that a user is expected to use the device for a longer period of time than a period of time for which the battery charge is expected to last.

The processor 224 can be configured to delay the transmission of the first SR 367 by a first amount of time (e.g., one or more time intervals 315) in response to determining that the state 330 is a first state 330 of a plurality of states 330. The processor 224 can identify a second state 330 indicative of at least one of the thermal 355 or the battery 340 condition of the wireless communication device 120. The processor 224 can determine to delay transmission of a second SR 367 of the plurality of SRs 367 by a second amount of time in response to the identified second state 330. For example, the first SR 367 can be delayed by one duration of an interval 315, while a second SR 367 can be delayed by two or three 315 intervals. The first SR 376 can correspond to data of an application that is a high priority application, while the second SR 376 can correspond to data of an application that is a low priority application.

The processor 224 can be configured to determine, in response to the identified state 330, to delay transmission of at least one SR 367 of the plurality of SRs 367 for at least the first time interval 315 of the plurality of time intervals 315. The at least one SR 367 corresponding to at least one application 380 executing on the wireless communication device 120. The processor 224 can be configured to identify that a first priority 385 is assigned to a first application 380 executing on the wireless communication device 120 and a second priority 385 is assigned to a second application 380 executing on the wireless communication device 120. The processor 224 can determine, in response to the first priority 385 being higher than the second priority 385 (or the second priority not meeting a defined threshold), to delay transmission of the first SR 367 for at least the first time interval 315. The first SR 375 can correspond to the second application 380. The processor 224 can transmit, via the transceiver in response to the first priority 385 being higher than the second priority 385, a second SR 367 of the plurality of SRs 367 corresponding to the first application 380, at the first time interval 315. The processor 224 can be configured to determine, in response to the identified state 330, to delay transmission of at least one SR 367 of the plurality of SRs 367 for at least the first time interval 315 until a buffer threshold is met. The buffer threshold can be a threshold of a buffer 375 in memory 226. For example, a buffer threshold for a first buffer 375 for storing SRs 367 from high priority applications can be set to a smaller threshold value so that the buffer threshold gets reached and is emptied more often (e.g., within a smaller number of time intervals 315) than a buffer threshold for a second buffer 375 for storing SRs 367 from lower priority applications which can be set to a larger threshold value so that the buffer threshold gets reached less often (e.g., within a larger number of time intervals) than the first buffer 375.

In some aspects, the present solution relates to a non-transitory computer readable medium storing program instructions for causing at least one processor 224 of a device 120 receive a configuration (e.g., SR configuration 310). The configuration (e.g., 310) can be a configuration to transmit a plurality of scheduling requests (SRs) 367 for uplink wireless communication in accordance with a periodicity defined by a plurality of time intervals 315. The program instructions can cause the processor 224 to identify a state 330 indicative of at least one of a thermal 340 or a battery 355 condition of the wireless communication device. The program instructions can cause the processor 224 to determine, in response to the identified state 330, to delay transmission of a first SR 367 of the plurality of SRs 367 for at least a first time interval 315 of the plurality of time intervals 315. The program instructions can cause the processor 224 to transmit the first SR 367 at a second time interval 315 of the plurality of time intervals 315 in accordance with the determining.

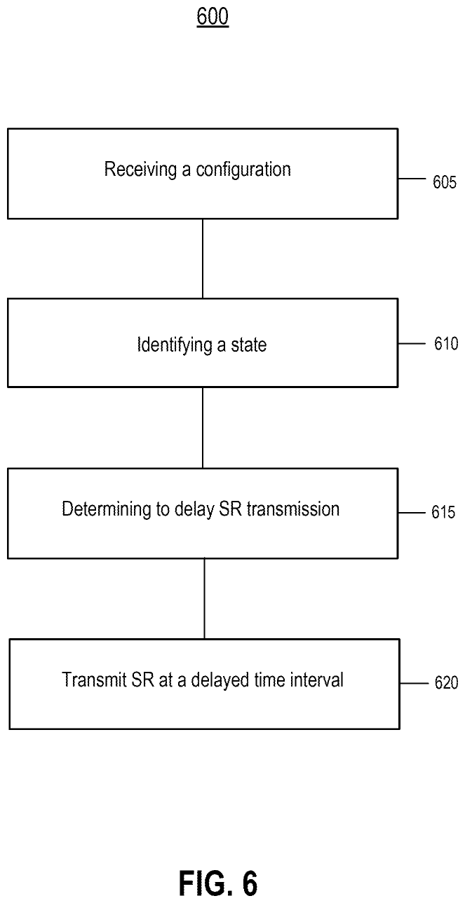

FIG. 6 illustrates an example flowchart of a method 600 for delaying or offsetting transmission of scheduling requests SRs for uplink wireless communication in order to mitigate thermal and/or battery conditions. Method 600 can include ACTS 605-620. The method 600 can be performed, for example, by one or more components of the battery system, such as those in the examples that are illustrated and discussed in connection with FIGS. 3-5. At ACT 605, the method includes receiving a configuration. At ACT 610, the method includes identifying a state. At ACT 615, the method includes determining to delay SR transmission. At ACT 620, the method includes transmitting SR at a delayed time interval.

At ACT 605, the method includes receiving a configuration. The method can include receiving, by a wireless communication device, an SR configuration. The SR configuration can be a configuration or a setting to transmit a plurality of scheduling requests (SRs) for uplink wireless communication in accordance with a periodicity, or a rate, defined by a plurality of time intervals. The SR configuration can be received by the wireless communication device (e.g., a UE) from a remote base station. The SR configuration can set the periodicity based on a set time interval between each of the SR transmissions to be made. The periodicity can correspond to a rate, such as a rate of one transmission every 5 ms, 10 ms, 15 ms, 20 ms, 30 ms, 40 ms, 60 ms, 80 ms or more than 80 ms.

At ACT 610, the method includes identifying a state. The method can include the wireless communication device identifying a state indicative of at least one of a thermal or battery condition of the wireless communication device. The thermal state or condition can correspond to a buildup of heat in a circuit of a wireless communication device, such as a power amplifier or a processor. The battery state or a condition can correspond to a rate at which a battery is being discharged or an amount of charge remaining in the battery. The method can include identifying, by the wireless communication device, the thermal condition corresponding to a circuit used for the uplink wireless communication. The circuit with respect to which the thermal condition is identified can be a power amplifier used for uplink communication by the wireless communication device. The circuit can include a processor, a controller or any other component of a wireless communication device.

The method can include detecting, by the wireless communication device, that the thermal condition exceeds (and/or meets) a thermal threshold. The thermal condition can correspond to or be indicative of at least one of: temperature, heat, electrical current, voltage or power, corresponding to the circuit. The method can include detecting/determining, by the wireless communication device, that the battery condition passes a battery threshold. The battery condition can be indicative of at least one of: an amount of charge remaining in the battery, a state of charge of the battery, a battery life of the battery, a rate of discharge of the battery or a temperature of the battery.

The method can include identifying, by the wireless communication device, that a first priority is assigned to a first application executing on the wireless communication device and a second priority is assigned to a second application executing on the wireless communication device. A first set of SRs can correspond to the first application of the first priority and a second set of SRs can correspond to the second application of the second priority.

At ACT 615, the method includes determining to delay SR transmission. The method can include determining, by the wireless communication device in response to the identified state, to delay transmission of a first SR of the plurality of SRs for at least a first time interval of the plurality of time intervals. The method can include determining, by the wireless communication device in response to the thermal condition exceeding (or meeting) the thermal threshold, to delay the transmission of the first SR. The method can include determining, by the wireless communication device in response to the battery condition passing the battery threshold, to delay the transmission of the first SR. The wireless communication device can determine to delay the transmission of the first SR by a first amount of time in response to determining that the state is a first state of a plurality of states. The wireless communication device can determine to delay the transmission of the first set of SRs by a first amount of time in response to determining that the first priority is lower than the second priority and/or a defined threshold.

The method can include identifying, by the wireless communication device, a second state indicative of at least one of the thermal or the battery condition of the wireless communication device. The method can include determining, by the wireless communication device, to delay transmission of a second SR of the plurality of SRs by a second amount of time in response to the identified second state. The method can include determining, by a modem of the wireless communication device, to delay transmission of the plurality of SRs for at least the first time interval of the plurality of time intervals. The plurality of SRs can correspond to a plurality of applications executing on the wireless communication device.

The method can include determining, by the wireless communication device in response to the first priority being higher than the second priority, to delay transmission of the first SR for at least the first time interval. The first SR can correspond to the second application. The method can include determining, by a modem of the wireless communication device in response to the identified state, to delay transmission of at least one SR of the plurality of SRs for at least the first time interval until a buffer threshold is met (or a time condition is met). The method can include delaying transmission of the first set of SRs corresponding to the first application of the first priority by a smaller time period than a time period by which the second set of SRs corresponding to the second application of the second priority is delayed.

At ACT 620, the method includes transmitting SR at a delayed time interval. The method can include transmitting, by the wireless communication device, the first SR at a second time interval of the plurality of time intervals in accordance with the determining. The method can include transmitting, by the wireless communication device in response to the first priority being higher than the second priority, a second SR of the plurality of SRs corresponding to the first application, at the first time interval. The method can include delaying transmission of the first set of SRs corresponding to the first application of the first priority in accordance with the time period, by an amount of time that is shorter than the amount of time by which the second set of SRs corresponding to the second application of the second priority is delayed.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

1. A method comprising:
receiving, by a wireless communication device, a configuration to transmit a plurality of scheduling requests (SRs) for uplink wireless communication in accordance with a periodicity defined by a plurality of time intervals;
identifying, by the wireless communication device, a state indicative of at least one of a thermal condition or a battery condition of the wireless communication device;
determining, by the wireless communication device in response to the identified state, to delay transmission of a first SR of the plurality of SRs by skipping more than one time interval of the plurality of time intervals of the periodicity and continue to delay the transmission of the first SR in accordance with the identified state until a buffer threshold is met; and
transmitting, by the wireless communication device, the first SR at a second time interval of the plurality of time intervals in accordance with the determining.

2. The method of claim 1, comprising:
identifying, by the wireless communication device, the thermal condition corresponding to a circuit used for the uplink wireless communication;
detecting, by the wireless communication device, that the thermal condition exceeds a thermal threshold; and
determining, by the wireless communication device in response to the thermal condition exceeding the thermal threshold, to delay the transmission of the first SR.

3. The method of claim 2, wherein the thermal condition is indicative of at least one of: temperature, heat, electrical current, voltage or power, corresponding to the circuit.

4. The method of claim 1, comprising:
detecting, by the wireless communication device, that the battery condition passes a battery threshold; and
determining, by the wireless communication device in response to the battery condition passing the battery threshold, to delay the transmission of the first SR.

5. The method of claim 4, wherein the battery condition is indicative of at least one of: an amount of charge remaining in the battery, a state of charge of the battery, a battery life of the battery, a rate of discharge of the battery or a temperature of the battery.

6. The method of claim 1, wherein the wireless communication device determines to delay the transmission of the first SR by a first amount of time in response to determining that the state is a first state of a plurality of states, the method further comprising:
identifying, by the wireless communication device, a second state indicative of at least one of the thermal or the battery condition of the wireless communication device; and
determining, by the wireless communication device, to delay transmission of a second SR of the plurality of SRs by a second amount of time in response to the identified second state.

7. The method of claim 1, comprising:
determining, by a modem of the wireless communication device, to delay transmission of the plurality of SRs by skipping more than two time intervals of the plurality of time intervals, the plurality of SRs corresponding to a plurality of applications executing on the wireless communication device.

8. The method of claim 1, wherein the first SR is an SR corresponding to an application.

9. The method of claim 1, comprising:
identifying, by the wireless communication device, that a first priority is assigned to a first application executing on the wireless communication device and a second priority is assigned to a second application executing on the wireless communication device;
determining, by the wireless communication device in response to the first priority being higher than the second priority, to delay transmission of the first SR for at least a first time interval, the first SR corresponding to the second application; and
transmitting, by the wireless communication device in response to the first priority being higher than the second priority, a second SR of the plurality of SRs corresponding to the first application, at the first time interval.

10. The method of claim 9, comprising:
determining, by a modem of the wireless communication device in response to the identified state, to delay transmission of at least one SR of the plurality of SRs for at least the first time interval until a buffer threshold is met.

11. A wireless communication device comprising at least one processor configured to:
receive, via a transceiver, a configuration to transmit a plurality of scheduling requests (SRs) for uplink wireless communication in accordance with a periodicity defined by a plurality of time intervals;
identify a state indicative of at least one of a thermal condition or a battery condition of the wireless communication device;
determine, in response to the identified state, to delay transmission of a first SR of the plurality of SRs by skipping more than one time interval of the plurality of time intervals of the periodicity and continue to delay the transmission of the first SR in accordance with the identified state until a buffer threshold is met; and
transmit, via the transceiver, the first SR at a second time interval of the plurality of time intervals in accordance with the determining.

12. The wireless communication device of claim 11, wherein the at least one processor is configured to:
identify the thermal condition corresponding to a circuit used for the uplink wireless communication;
detect that the thermal condition exceeds a thermal threshold; and
determine, in response to the thermal condition exceeding the thermal threshold, to delay the transmission of the first SR.

13. The wireless communication device of claim 12, wherein the thermal condition is indicative of at least one of: temperature, heat, electrical current, voltage or power, corresponding to the circuit.

14. The wireless communication device of claim 11, wherein the at least one processor is configured to:
detect that the battery condition passes a battery threshold; and
determine, in response to the battery condition passing the battery threshold, to delay the transmission of the first SR.

15. The wireless communication device of claim 14, wherein the battery condition is indicative of at least one of: an amount of charge remaining in the battery, a state of charge of the battery, a battery life of the battery, a rate of discharge of the battery or a temperature of the battery.

16. The wireless communication device of claim 11, wherein the at least one processor is configured to:
determine to delay the transmission of the first SR by a first amount of time in response to determining that the state is a first state of a plurality of states;
identify a second state indicative of at least one of the thermal or the battery condition of the wireless communication device; and
determine to delay transmission of a second SR of the plurality of SRs by a second amount of time in response to the identified second state.

17. The wireless communication device of claim 11, wherein the at least one processor is configured to:
determine, in response to the identified state, to delay transmission of at least one SR of the plurality of SRs by skipping more than two time intervals of the plurality of time intervals, the at least one SR corresponding to at least one application executing on the wireless communication device.

18. The wireless communication device of claim 11, wherein the at least one processor is configured to:
identify that a first priority is assigned to a first application executing on the wireless communication device and a second priority is assigned to a second application executing on the wireless communication device;
determine, in response to the first priority being higher than the second priority, to delay transmission of the first SR for at least a first time interval, the first SR corresponding to the second application; and
transmit, via the transceiver in response to the first priority being higher than the second priority, a second SR of the plurality of SRs corresponding to the first application, at the first time interval.

19. The wireless communication device of claim 18, wherein the at least one processor is configured to:
determine, in response to the identified state, to delay transmission of at least one SR of the plurality of SRs for at least the first time interval until a buffer threshold is met.

20. A non-transitory computer readable medium storing program instructions for causing at least one processor of a device to:
receive a configuration to transmit a plurality of scheduling requests (SRs) for uplink wireless communication in accordance with a periodicity defined by a plurality of time intervals;
identify a state indicative of at least one of a thermal or a battery condition of the device;
determine, in response to the identified state, to delay transmission of a first SR of the plurality of SRs by skipping more than one time interval of the plurality of time intervals of the periodicity and continue to delay the transmission of the first SR in accordance with the identified state until a buffer threshold is met; and
transmit the first SR at a second time interval of the plurality of time intervals in accordance with the determining.
